(19) United States
(12) Patent Application Publication
(10) Pub. No.: US 2006/0062491 A1
(43) Pub. Date: Mar. 23, 2006

(54) Techniques for image processing

(76) Inventor: Ernest P. Chen, Gilbert, AZ (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/944,575

(22) Filed: Sep. 17, 2004

(51) Int. Cl. G06K 9/60

(52) U.S. Cl. 382/303

(57) ABSTRACT

Techniques for image processing are provided. Image processing algorithms are linked together in an image processing plan. The image is piped through the processing plan, such that as results are produced by a particular image processing algorithm they are immediately provided to a next image processing algorithm of the image processing plan for processing.

### BACKGROUND INFORMATION

A typical image of decent quality (e.g., 600 dots per inch (DPI) on an 8½ by 11 page) may represent each pixel of that image as chrominance values with three bytes (red values, green values, and blue values (RGB)) of data for each pixel. The same image may use additional bytes for each pixel to represent other chrominance values, such as cyan, magenta, yellow, black, and others. The bytes may also include values for luminance. Thus, a typical image may occupy about 100 megabytes (MB) of storage.

Moreover, images may be processed and filtered in a variety of manners to alter the images appearance (e.g., bilinear-interpolated zooming, descreening, segmenting, alpha blending, histogram equalization, low-pass filtering, high-pass filtering, edge-detect filtering with thresholding, color converting, dithering and error diffusing, compressing, decompressing, morphing, scaling, zooming, etc.). Accordingly, a single image may be successively processed by a variety of different filters. As a result, image processing is taxing on memory and processor resources.

In order to reduce processing complexity and throughput a variety of approaches have been taken to process images more efficiently. One such technique breaks the image being processed into a series of smaller blocks, such that each block of image data (pixels) are processed as discrete groups through image filters. For example, an image may be segmented into four equally sized blocks of pixels. The first block is processed through a plurality of filters, when it completes the second block is processed through the series of filters, and so on until all four blocks have processed. The four filtered blocks are then merged together to form an enhanced or altered version of the original image.

Existing machine architectures may include a variety of memory and processor modules, such that as blocks are serially processed several of the modules not associated with processing a current block of the image remain under utilized or not utilized at all. Consequently, these approaches have failed to account for more modern machine architectures and their existing capabilities. As a result, existing approaches are not achieving maximum processing throughput.

### BRIEF DESCRIPTION OF THE DRAWINGS

FIG. 1 is a flowchart of a method for processing an image, according to an example embodiment.

FIG. 2 is a flowchart of another method for processing an image, according to an example embodiment.

FIG. 3 is a flowchart of a method having instructions in a medium for processing an image, according to an example embodiment.

FIG. 4 is a diagram of an image processing apparatus, according to an example embodiment.

FIG. 5 is a diagram of an image processing system, according to an example embodiment.

### DESCRIPTION OF THE EMBODIMENTS

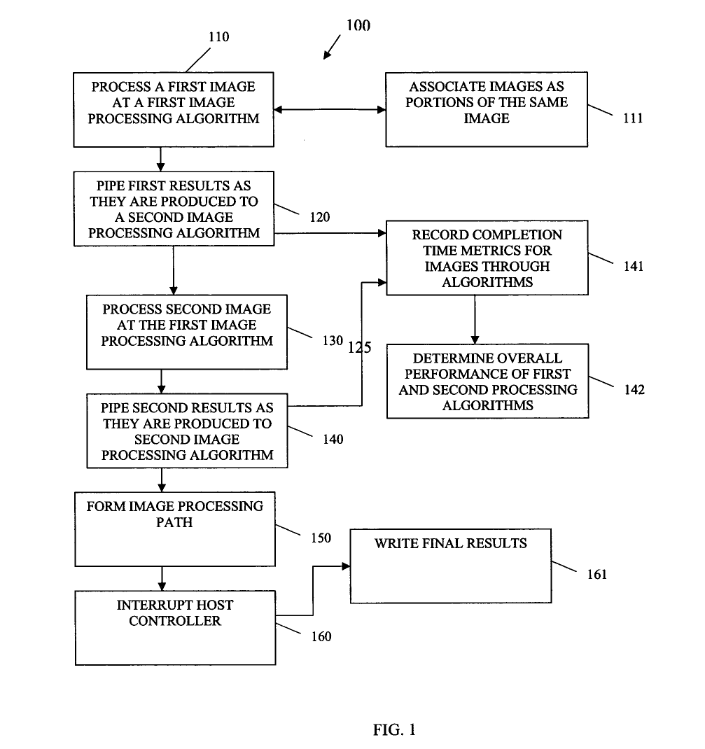

FIG. 1 illustrates a flowchart of one method 100 for processing an image, according to an example embodiment. The method 100 is implemented in a machine accessible medium and/or machine. However, the method 100 may be implemented in many manners, such as, and by way of example only, the method 100 may be implemented as a series of signals, as a part of a hardware implementation, combinations of hardware and/software, etc. In an embodiment, the method 100 is implemented as microcode loaded and processed within a parallel processor's architecture, such as Intel's® MXP Digital Media Processor. Of course, the method 100 may be implemented in a variety of machines, media, and/or architectures.

As used herein an “image” may be considered a logical grouping of one or more pixels. Thus, an image may be segmented in any configurable manner into a series of blocks, swaths, or portions, such that each block, swath, or portion is itself an image. In this manner, any logical segmentation of pixels can combine with other segmentations to form a single or same image. Conversely, a single segmentation may be viewed as a single image.

An “image processing plan” is a logical linkage of different image processing algorithms. An image processing algorithm performs some alteration on values associated with pixels of the image, such as, but not limited to: morphing, zooming, scaling, chrominance enhancing, luminance enhancing, dithering, color converting, compressing, decompressing, edge detecting, image segmenting, and other types of image filtering. The image processing plan is in a sense a workflow or path through a discrete set of available image processing algorithms.

The term “piping” is commonly used and understood in the programming arts and refers to the ability to transmit data as it is received or produced without the need to buffer the data until some particular processing completes or until some configurable amount of data is accumulated. For example, suppose a particular set of data (D) is processed by a first algorithm A1. A1 produces another set of data (D′) from D. D′ is processed by another algorithm A2. In this example, D is sent to A1 as soon as A1 produces any portion of D′; that portion is immediately transmitted to A2 for processing. With piping techniques, A2 does not have to wait to begin processing until the entire set of D′ is produced from A1; rather, A2 initiates processing as soon as A1 produces any portion of D′. Moreover, the data may be instructions processed by a machine. For example, an instruction (data) within a machine may be in a fetch stage, decode stage, or execute stage; and the final result in a write-back stage. While one instruction is moved into a decode stage, the next instruction can move into the fetch stage. Thus, as a first instruction (data) moves through the rest of the instruction stages, the subsequent instructions (data) also get pulled through.

Initially, at 110, a first image is received and processing initiated at a first image processing algorithm. In an embodiment, the first image may be received from a host controller interfaced to a microchip, where that microchip includes an executing instance of method 100 loaded thereon. Moreover, the microchip may have a parallel driven architecture, such that a variety of processors and memory are available on the microchip.

In an embodiment, the method 100 processes at least two images. Some of that processing as will be described in greater detail below may occur in separate image processing algorithms. Furthermore, some processing may occur concurrently and in parallel with other processing. Thus, in an embodiment, at 111, a first and second image are processed by the method 100 and the first and second images are recognized and associated by the method 100 as portions of a same global image. That is, in an embodiment, the global image is segmented into two separate images: the first image and the second image.

Once the first image is received by the first image processing algorithm, the first image is immediately processed. During processing first results are continuously being produced as pixels of the first image are altered or not altered based on the processing logic of first image processing algorithm. At 120, the first results are piped to a second image processing algorithm, where, at 130, the first results are immediately processed by the logic of the second image processing algorithm.

The first image processing algorithm continues to process the first image as the second image processing algorithm concurrently processes the first results being produced by the first image processing algorithm. In this manner, efficiency is gained because the second image processing algorithm begins processing and concurrently processes the first results while the first image processing algorithm processes the first image.

As soon as the first image processing algorithm completes processing for the first image, at 130, a second image is received at and processed by the first image processing algorithm. That is, as soon as the method 100 receives an event indicating that the first image processing algorithm is finished with the first image, the second image is immediately provided to the first image processing algorithm for processing. In some cases, the first image processing algorithm is starting processing for the second image, while the second image processing algorithm is wrapping up or continuing with its processing on the first results associated with the first image.

In a similar manner to the processing depicted at 120, the first image processing algorithm produces second results for the second image which are, at 140, piped directly to the second image processing algorithm. The second image processing algorithm accumulates final results associated with both the first results and the second results.

In an embodiment, at 141, the method also maintains or records completion time metrics for the first and second image processing algorithms. The metrics record start and ending times or elapsed times associated with each image processing algorithm's processing of each image. At 142, the metrics may be used to compute an overall performance for each of the algorithms. One technique for doing this is to average a particular image processing algorithm's time metrics for both the first and second images.

The time metrics may also assist a reprographic vendor or developer in iterating the method 100 with a variety of images and image processing algorithms for purposes of determining an optimal (in terms of processing throughput) path for processing images. That path links or associates the identified best performing image processing algorithms together to form an image processing plan. Correspondingly, in an embodiment, at 150, an image processing path may be logically identified and defined by linking the processing of 120 and 140 together as a plan or path for the first and second images.

In another embodiment, at 160, once the method 100 receives an event notification that the second image processing algorithm has completed processing against the second results, the method 100 may issue an interrupt to a host controller interfaced to the method 100. The interrupt is used, at 161, to write the final results produced by the second image processing algorithm. In an embodiment, an interrupt controller may be used at various intermediate stages of the method 100 to adjust for certain processing parameters. For example, data may be reconfigured into different formats between Direct Memory Access (DMA) channels, any hardware accelerators may be reconfigured, and/or new look-up tables may be loaded into memory. In this manner, the machine or microchip that executes the method 100 is optimized since communication between the microchip and a host controller interfaced to the microchip is minimized and reserved for receiving the initial images and then for communicating the final results. Therefore, processing throughput for processing the images is increased.

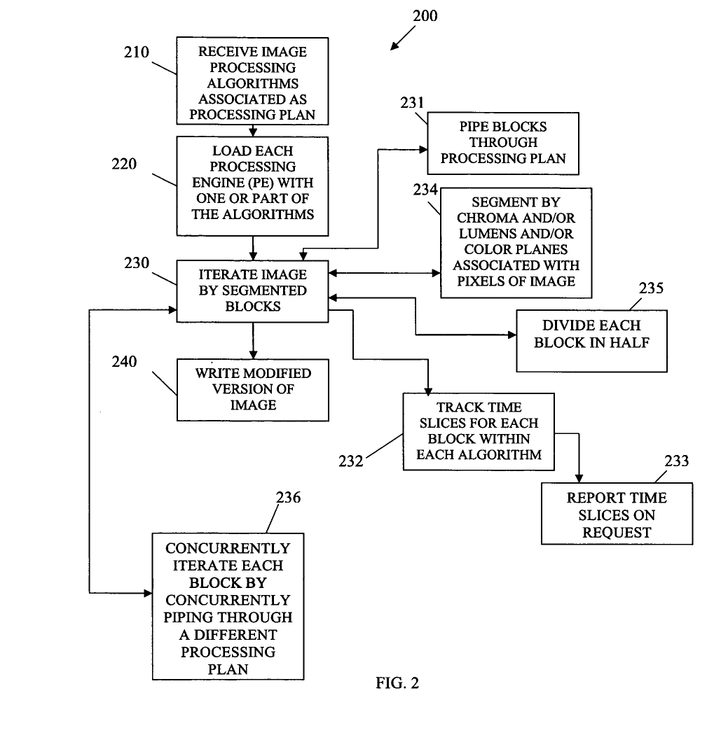

FIG. 2 depicts a flowchart of another method 200 for processing an image, according to an example embodiment. The method 200 is implemented within a machine accessible medium and/or a machine. The method 200 may therefore be implemented in software, hardware, firmware, or various combinations of the same. In an embodiment, the method 200 is implemented and processed with a parallel driven microprocessor's architecture.

Initially, in an embodiment, the method 200 is interfaced to a host controller, and the host controller interfaced to other Application Programming Interfaces (APIs) for purposes of interacting with a user, such as a reprographic vendor or developer. At 210, image processing algorithms are received and associated with one another as an image processing plan. The image processing plan may be viewed as a data structure that links the addresses or identifiers associated with the image processing algorithms in a sequential and predefined order.

Based on the identifiers for the image processing algorithms included in the plan, the method 200 processes to acquire and load each of the image processing algorithms, at 220, into programmable processing engines (PEs). A single image processing algorithm is loaded into one of the PE's. Some PE's may reside on a same processor instance within a machine and some PE's may reside on different processor instances with the machine. Moreover, it should be pointed out that in various embodiments, a single image processing algorithm may reside in less than one PE and thus across multiple PE's.

Once the image processing algorithms and the plan is acquired and loaded into the PE's, the method 200 processes to iterate an image received from the host controller, which is interfaced to the method 200. The image is segmented into configurable blocks. That is, the image is reduced to smaller discrete sizes for purposes of increasing processing throughput through the plan. At 231, the blocks of the image are piped though the plan. This occurs in the manners described above with respect to the method 100 of FIG. 1.

In an embodiment, at 232, as the blocks are processed through the plan, time slices for each block processed within each algorithm may be tracked. A time slice may include two time metrics, a start time for an algorithm and a block and an end time (processing completion time). Alternatively, a time slice may include a single time metric representing the elapsed time for a block to be completely processed by an algorithm. At 233, the time slices may be reported upon request from a host controller. Other applications accessible to the host controller may then process the time metrics to determine processing performance metrics for each of the image processing algorithms associated with the image processing plan.

As described above the image being processed by the method 200 may be segmented into a variety of configurable blocks in order to reduce the size of the image data being processed through the method 200. In an embodiment, at 234, one such segmentation may be achieved by segmenting the image into chrominance or luminance block bands or planes. That is, it may be that the plan includes algorithms that alter or filter the images' color planes or light planes. For example, suppose that the plan is associated with enhancing an image's red, green, and blue color planes. In this example, the image may be segmented into three blocks one for red pixel values, one for green pixel values, and one for blue pixel values. In a similar manner, the image may be segmented based on luminance characteristics.

In another embodiment, at 235, the image may be segmented into the blocks as discussed above in any configurable manner, and each of those blocks are further subdivided into halves. Each of the halves may then be viewed as a block itself. One reason for doing this is that the original blocks themselves may be larger than what is desired. Thus, by halving the blocks each PE within the plan having an algorithm requires less memory to process a halved block. As a result, the processing throughput through each algorithm may be further reduced. Determinations as to whether to halve the blocks may be based on testing and performance metrics for a given plan and given image. Moreover, in some instances, the blocks may be divided in different configured amounts; such that one block is divided into two or more unequal portions.

In yet another embodiment, at 236, the method 200 may concurrently process two separate and different image processing plans for the same image in parallel. This can be achieved when multiple and independent processing is to be performed on the image. For example, an image may be processed based on chrominance planes and independently processed based on luminance planes. In this example, one plan may have a series of image processing algorithms for processing chrominance characteristics and another plan may have a series of different image processing algorithms for processing the luminance characteristics. In this embodiment, the machine implementing the method 200 has a parallel processor's architecture.

Once all blocks have exited the last image processing algorithm of the image processing plan; a modified version of the original image is produced, at 240. Again, in an embodiment, this can be achieved by issuing an interrupt to the host controller and writing the modified version of the original image to storage and/or memory. Thus, in one embodiment, an interrupt controller may be used to adjust for processing parameters of the method 200 to convert data formats, reconfigure any hardware accelerators, and/or load any new look-up tables.

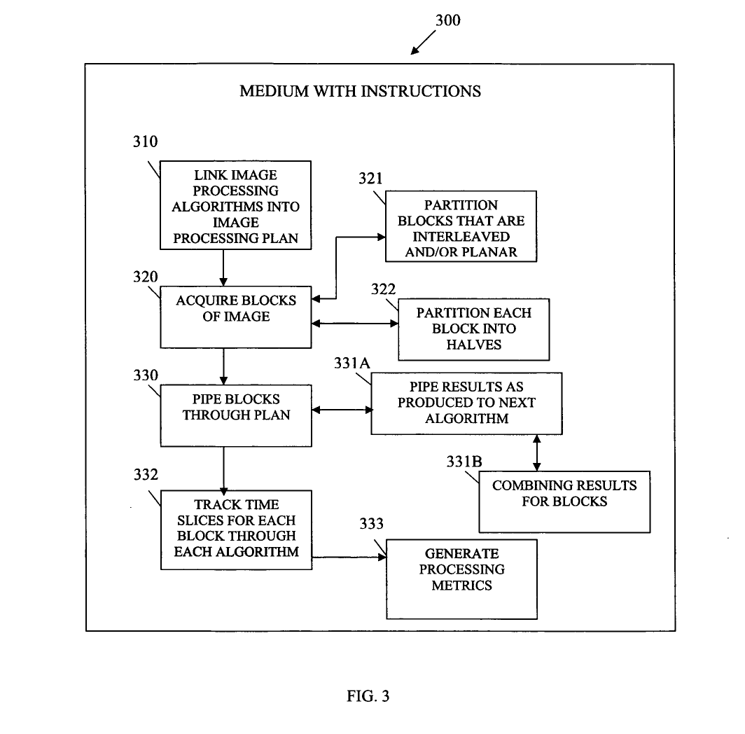

FIG. 3 illustrates a flowchart of a method 300 having instructions in a medium for processing an image, according to an example embodiment. The instructions reside in a machine accessible medium. Furthermore, the instructions may reside on multiple media and logically associated with one another as a single logical medium. Additionally, the medium may be removable, permanent, and/or remote. Thus, the instructions may be interfaced to a machine and uploaded or the instructions may be interfaced to a machine via a download from another machine, another storage location, or another memory location. Once the instructions are loaded and processed (accessed), they perform the processing depicted in FIG. 3, which represents the method 300.

At 310, image processing algorithms are linked together to form an image processing plan. The plan represents a path for an image to be processed by the instructions. Essentially, the plan is a data structure identifying the image processing algorithms is a sequential order, such that the first identified image processing algorithm is the first to process the image, and the last identified image processing algorithm is the last to process the image. In some cases some image processing algorithms may also be identified in parallel order within the plan, indicating these particular algorithms may process concurrently with one another.

The identified image processing algorithms are loaded into and executed within the machine that is processing the instructions. At some point after this, an image or a portion of an image to be processed is identified to the instructions. This can occur via interfaces associated with the instructions, that receive a command to process the plan for a given image or portion of an image.

Accordingly, at 320, the instructions acquire blocks of the image. Acquisition may occur by using a handle or a reference to certain blocks of the image, which permits the instructions to retrieve the blocks from storage, memory, and/or registers. Moreover, a single block of the image does not have to reside in a single location, such that the instructions may assemble a block during acquisition, at 320, from multiple locations. In another embodiment, a predefined amount of blocks are acquired and housed in memory of the machine processing the instructions during acquisition, at 320.

In an embodiment, at 321, the blocks may be partitioned and in some cases the partition may be associated with blocks that are interleaved and/or planar. Interleaved blocks are blocks that have both color and/or light characteristics represented in single packed pixel values. Conversely, planar blocks are blocks where color and/or light characteristics are independently represented within the pixel values. Additionally, some blocks may be interleaved while other blocks are planar.

In another embodiment, at 322, each block may be further subdivided into halves. This can occur in the manners and techniques discussed above with respect to method 200 of FIG. 2. In certain situations, halving the blocks may further increase processing throughput for the image, since any parallel processing engines that may process the instructions are kept busier, such that more data is processed in less time. In other words, engines that may otherwise be idle are used when a block is halved; so, a whole block processes faster when multiple processing engines concurrently process portions of that whole block in parallel.

At 330, once the blocks of the image are acquired and segmented in a desired and configurable manner, each block is piped through the image processing plan. This means that as a particular algorithm of the plan begins to produce results for a particular block, the results as they are produced are not buffered; rather, the results are piped and sent to a next algorithm of the plan for immediate processing, at 331A. At, 331 B the results are combined for each block being processed. The combined results represent a modified version of the original image being processed.

The plan may be optimized and evaluated by users, such as reprographic vendors or developers. One technique to facilitate this is depicted at 332, where time slices are recorded for each block that is processed through each image processing algorithm of the plan. Thus, at 333, performance or processing metrics may be produced.

In an embodiment, the metrics may be generated by the instructions or alternatively the time slices may be sent to other applications for purposes of generating the metrics. In an embodiment, the instructions resolve a performance or processing metric for any particular algorithm of the plan by averaging that algorithm's time slices for all processed blocks of the image.

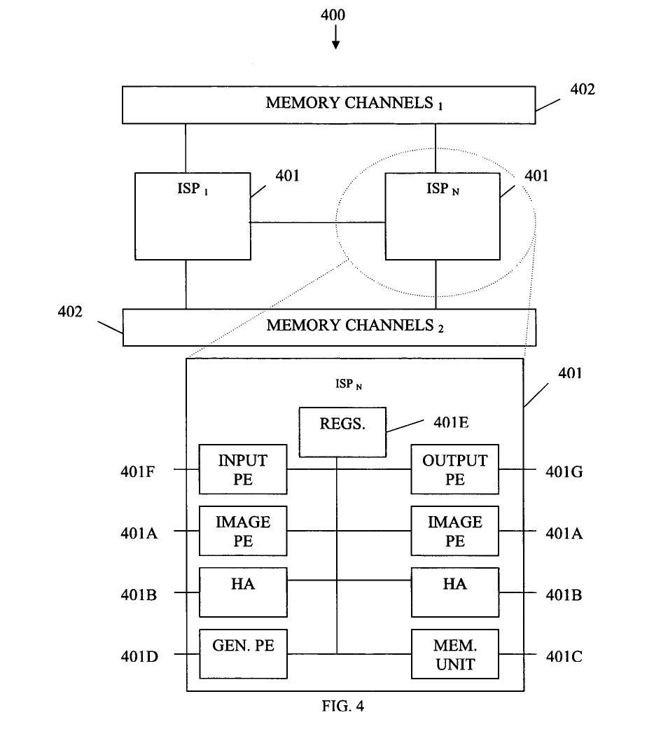

FIG. 4 depicts a diagram of an image processing apparatus 400, according to an example embodiment. The apparatus 400 represents a device or a machine that is adapted to perform the methods 100 and 200 of FIGS. 2 and 3. Moreover, the apparatus 400 is adapted to load and process the instructions represented by method 300 of FIG. 3. FIG. 4 is presented for purposes of illustration only, thus the configuration and arrangement of the apparatus may be altered with other components added or removed without departing from the embodiments of the invention presented herein.

The apparatus 400 includes a plurality of image signal processors (ISP's) 401 and a plurality of programmable processing engines (PEs) 401A. FIG. 4 depicts an exploded view of the contents of an example ISP 401. The PE's 401A are included with the ISP's 401A. Moreover, each PE 401A is adapted to load and process a particular image processing algorithm. In an embodiment, a single image processing algorithm may also span multiple PE's 401A. Furthermore, the algorithms combine with one another in groups to form image processing plans for an image. The image processing plan may be fed to the apparatus 400 as a data structure residing in memory.

The apparatus 400 is adapted to process an image segmented into blocks by piping each block through the PE's 401A according to the dictates defined in the image processing plan. This may occur in the manners discussed above with the methods 100, 200, and 300.

In an embodiment, the apparatus 400 includes a variety of other components that assist in processing blocks of an image through the apparatus 400. For example, in an embodiment, the apparatus 400 may include one or more hardware accelerators (HA's) 401B. The HA's 401B assist in accelerating image processing functions which are not efficiently done by provided instructions set of a given PE 401A.

The apparatus 400 may also include a memory unit 401C that provides local storage or memory for the PE's 401A of the ISP 401. Additionally, the apparatus 400 may include additional PE's 401D (identified as a general PE 401D in FIG. 4) that provide processing via specialized instructions designed to assist the image processing algorithms within a given PE 401A in communication with other ISP's 401 or in performing certain laborious or process-intensive arithmetic operations. Moreover, the apparatus 400 may include its own registers 401 E designed to facilitate communications between the PE's 401A, 401D, 401F, and 401G; the HA 401B; and the memory unit 401C.

The apparatus may also include an Input PE 401F which is designed to handle incoming blocks associated with the image or to handle results produced by other image processing algorithms processing in other PE's 401A of other ISP's 401. In a like manner, the apparatus 400 may include an output PE 401G designed to facilitated outgoing results produced by image processing algorithms that process within a PE 401A, where the outgoing results are directed to other PE's 401A of other ISP's.

The apparatus 400 may also be arranged such that each ISP 401 is interfaced to one or more memory channels 402. The memory channels 402 permit initial blocks of an image to be communicated to an appropriate first PE 401A residing within a specific ISP 401. Furthermore, the memory channels 402 permit final results associated with a processed image to be communicated to a host controller and written to other memory or storage.

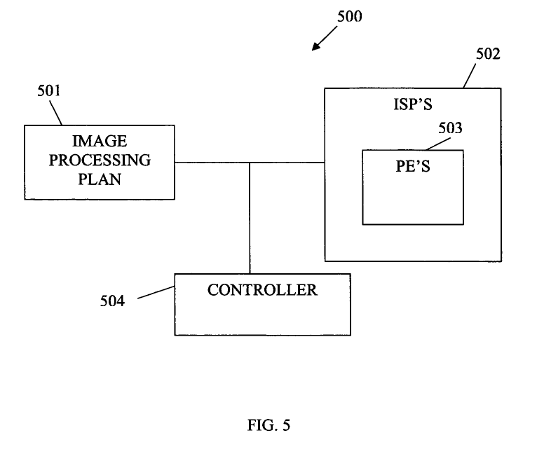

FIG. 5 illustrates a diagram of an image processing system 500, according to an example embodiment. The image processing system 500 is implemented in a combination of hardware and software. In an embodiment, the image processing system 500 is implemented as the apparatus 400 of FIG. 4 and as the methods 100, 200, and 300 of FIGS. 1-3. During operation, the image processing system 500 processes an image by piping portions of the image through the hardware, which processes image processing algorithms.

The image processing system 500 may include an image processing plan 501, a plurality of ISP's 502, and a plurality of PE's 503. In an embodiment, the image processing system 500 also includes a controller 504 that manages and conforms to the tenets of the image processing plan 501.

The image processing plan 501 is operable to define a plurality of image processing algorithms which are logically associated with one another to form a path through a discrete set of PE's 503. Each PE 503 includes one of the image processing algorithms. In another embodiment, a single image processing algorithm may span multiple PE's 503. Therefore, each image processing algorithm is adapted to be loaded and processed within a particular PE 503 or a particular set of PE's 503.

The image processing system 500 is adapted to receive blocks of an image and to pipe each block through the image processing plan 501. In one embodiment, this is achieved by a controller 504, which in response to the image processing plan interfaces and transitions blocks of the image from one image processing algorithm processing in one PE 503 to another image processing algorithm processing in another PE 503.

In an embodiment, at least one of the ISP's 502 may include two different PE's 503, such that each different PE 503 includes a different one of the image processing algorithms associated with the image processing plan 501. Moreover, in some arrangements, the PE's 503 having image processing algorithms of the image processing plan 501 may all reside on different ISP's 502.

In an embodiment, the image processing system 500 performs the techniques presented above in methods 100, 200, and 300 of FIGS. 1-3 using a machine similar to the apparatus 400 of FIG. 4. In still another embodiment, the image processing system 500 is implemented within any parallel processor's architecture.

The above description is illustrative, and not restrictive. Many other embodiments will be apparent to those of skill in the art upon reviewing the above description. The scope of embodiments of the invention should therefore be determined with reference to the appended claims, along with the full scope of equivalents to which such claims are entitled.

The Abstract is provided to comply with 37 C.F.R. §1.72(b) in order to allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting an intention that the claimed embodiments of the invention have more features than are expressly recited in each claim. Rather, as the following claims reflect, inventive subject matter may lie in less than all features of a single disclosed embodiment. Thus the following claims are hereby incorporated into the Description of the Embodiments, with each claim standing on its own as a separate exemplary embodiment.

What is claimed is:

1. A method, comprising:
(a) processing a first image at a first image processing algorithm;
(b) piping first results as they are produced from the first image processing algorithm to a second image processing algorithm;
(c) processing a second image at the first image processing image; and
(d) piping second results as they are produced from the first image processing algorithm to the second image processing algorithm.

2. The method of claim 1 further comprising, associating the first image and the second image as portions of a same image.

3. The method of claim 1 further comprising, recording completion time metrics for each of the first and second images through the first and second processing algorithms.

4. The method of claim 3 further comprising, determining an overall performance for the first image processing algorithm and the second image processing algorithm based on the completion time metrics.

5. The method of claim 1 further comprising, forming an image processing plan represented by (b) and (d) which may be reused for processing subsequent images.

6. The method of claim 1 further comprising:
interrupting a host controller after (d) completes; and
writing final results produced from the second image processing algorithm.

7. A method comprising:
receiving a plurality of image processing algorithms associated with an image processing plan;
loading each of a plurality of programmable processing engines (PEs) with one of the image processing algorithms; and
iterating an image segmented into configurable blocks, wherein each configurable block is piped through the image processing plan and once a modified configurable block exits a particular image processing algorithm a next configurable block enters the particular image processing algorithm.

8. The method of claim 7 further comprising, writing a modified version of the image after the iterating completes.

9. The method of claim 7, wherein iterating further includes issuing interrupts to a host controller to acquire different ones of the configurable blocks if the different ones are not available in memory.

10. The method of claim 7, wherein iterating further includes tracking time slices between each image processing algorithm in the image processing plan for each configurable block.

11. The method of claim 10 further comprising, reporting the time slices upon request to a host controller.

12. The method of claim 7, wherein iterating further includes segmenting the configurable blocks based on at least one of chrominance, luminance, chrominance planes, and luminance planes associated with pixels of the image.

13. The method of claim 7, wherein iterating further includes dividing each configurable block in half before performing the iteration.

14. The method of claim 7, further comprising concurrently iterating the configurable blocks, wherein each configurable block is concurrently piped through a different image processing plan having different image processing algorithms, which are loaded to different PE's.

15. A machine accessible medium having associated instructions, which when processed, results in a machine performing:
linking image processing algorithms into an image processing plan;
acquiring blocks of an image; and
piping the blocks through the image processing plan, wherein as results are produced from a particular image processing algorithm for a particular block, the results are piped to a next image processing algorithm associated with the image processing plan, and a next block is directed to the particular image processing algorithm.

16. The medium of claim 15, wherein the instructions further include tracking time slices for each block processed through each image processing algorithm of the image processing plan.

17. The medium of claim 16, wherein the instructions further include generating processing performance metrics for each image processing algorithm by averaging each image processing algorithm's time slices.

18. The medium of claim 15, wherein the instructions further include writing a modified version of the image once each block has processed through the image processing plan.

19. The medium of claim 15, wherein the instructions further include partitioning the blocks to include portions of the image that are at least one of interleaved and planar.

20. The medium of claim 15, wherein the instructions further include partitioning each of the blocks into halves and piping the halves for each block through the image processing plan.

21. An apparatus, comprising:
a plurality of image signal processors (ISP's); and
a plurality of programmable processing engines (PEs) embedded within each ISP;
wherein each PE is adapted to load and process an image processing algorithm, the image processing algorithms adapted to be linked together in order to form an image processing plan for an image, and wherein the image is segmented into blocks, each block adapted to be piped through the image processing plan via the PE's.

22. The apparatus of claim 21 further comprising, one or more hardware accelerators embedded within each ISP that is adapted to accelerate operations of a number of image processing algorithms.

23. The apparatus of claim 21 further comprising, a memory unit within each ISP which is adapted to provide local storage for each PE embedded within that ISP.

24. The apparatus of claim 21 further comprising, a number of additional PE's within each ISP that includes specialized instructions to assist the image processing algorithms and to assist in performing arithmetic operations and to assist in communicating with other ones of the ISP's.

25. A system, comprising:
a plurality of image signal processors (ISP's);
a plurality of programmable processing engines (PEs) embedded within each ISP; and
an image processing plan operable to define a plurality of image processing algorithms linked together to form an image processing path, wherein each image processing algorithm is adapted to be loaded into one of a plurality of the PE's;
wherein the system is adapted to receive blocks of an image and adapted to pipe each block through the image processing plan.

26. The system of claim 25 further comprising, a controller that is adapted to interface and to transition the blocks of the image through each of the PE's in order to be processed by each of the image processing algorithms of the image processing plan.

27. The system of claim 25, wherein at least one ISP is adapted to include one or more of the image processing algorithms of the image processing plan through two or more of the PE's.

28. The system of claim 25, wherein the system is implemented within a parallel processor's architecture.
